(19) United States
(12) Patent Application Publication
(10) Pub. No.: US 2013/0254396 A1
(43) Pub. Date: Sep. 26, 2013

(54) SYSTEM AND METHOD FOR CLIENT VERIFICATION AND AUTHENTICATION

(71) Applicant: Lynn Robertson, Seattle, WA (US)

(72) Inventor: Lynn Robertson, Seattle, WA (US)

(21) Appl. No.: 13/621,228

(22) Filed: Sep. 15, 2012

Related U.S. Application Data
(60) Provisional application No. 61/534,896, filed on Sep. 15, 2011.

(51) Int. Cl. H04L 12/24

(52) U.S. Cl. CPC H04L 41/50
USPC 709/225

(57) ABSTRACT

System and method of authenticating a user's identifying information for improving security in the context of buyer/seller transactions. A user submits identifying information through a registration website and system. The system sends the user's mobile device a code. The user returns the code via the website, the system confirms the code and records confirmation of the mobile device. The user submits additional identifying information which is checked by the registration system administrators and/or automatically verified by software. The user is recorded as authenticated if both their mobile device and additional identifying information are determined to be authentic and meet all predetermined standards. Interested parties may be notified of such authentication. The registration website allows pairs of authenticated users to connect and sends each member a verifying code and the other's photograph so that users may view and check these materials before and at any eventual in-person meeting.

### CROSS-REFERENCE TO RELATED APPLICATIONS

This application claims the benefit of U.S. provisional application Ser. No. 61/534,896 filed Sep. 15, 2011 by the pie sent inventor, and which is incorporated herein by reference in its entirety.

### FIELD OF THE INVENTION

The present invention generally relates to identity authentication. The invention more particularly relates to creating, managing, and presenting user identity authentication information for use associated with in-person, buyer-seller transactions.

### BACKGROUND

This authentication system and method relates to the security of persons involved with in-person buyer-seller transactions, as well as the security of physical property located at a transaction meeting site.

Today, many items intended for sale are advertised on the internet, in newspaper ads, or on posted flyers. In most cases, the buyer and seller are strangers to one another, and it can be dangerous to meet the other party in person. Similarly, it can be dangerous for sales professionals and property owners to meet with strangers on vacant property or at any location where such professionals and owners are alone. Additionally, items stored at or left unattended at open houses or vacancies often go missing, are vandalized, or are destroyed. Casual buyers and sellers, real estate professionals. and other sales professionals have long desired a method of ascertaining who they will be meeting with and to whom they will allow access to property.

In the past, casual buyers and sellers have attempted to ameliorate some of the dangers of meeting a stranger in person by various methods. One method involves agreeing to meet in a public place. This may not always work well, as being in a public place does not guarantee personal safety, and the item/s to be sold may not be mobile. A second method is agreeing to allow additional persons to accompany the buyer/seller, but additional persons are often unwilling or unavailable to accompany the buyer/seller, and historically, a second person has not necessarily discouraged a crime. A buyer or seller may choose to not bring cash or anything of value to an in-person meeting, but risks to both parties still exist, as robbery may not be the sole motivation for a crime. This method may also delay any eventual transaction. Sellers may choose to use a seller's service that facilitates such transactions, but such services require additional time, frequently receive a significant portion of the sale proceeds, and are often less efficient because they cannot represent the sale item with the same accuracy as the owner.

In the real estate field, one attempted method of circumventing some of these problems has been to keep a written list of “safe” clients—that may or may not be shared with other agents. This method has several disadvantages. First, it only becomes useful to other real estate professionals after something negative has occurred and the client's identifying information has already been recorded. Thus, the benefit offered is strictly retroactive. Second, a client list requires diligent and frequent updating—something a busy real estate professional may have little time to perform. Third, such lists are not centralized or formally organized; sharing between different entities can invoke client privacy and/or business piracy concerns. Dishonest or violent clients frequently move to other agencies in order to avoid detection, making decentralized lists less useful.

Another attempted method has been to have sales and real estate professionals meet clients in their of ice prior to showing a property. During this visit, the professional is supposed to make a copy of the client's driver's license and leave it with another individual in the office. This method has proven antiquated and unpopular as the internet has become the primary mode of scheduling appointments; meetings no longer take place in offices, because they usually occur at the properties themselves. Subsequently, sale and real estate professionals often meet clients in person without any means of prior identity confirmation. This leaves the professional or property seller unprotected and at risk of harm.

In conclusion, insofar as I am aware, no method of proactive, efficient, timely, and centralized buyer-seller authentication for such sales professionals exists.

### SUMMARY

Use present embodiment of this authentication system and method relates to an internet- and mobile phone-based method of verifying and authenticating a user's identity. If a potential buyer and seller wish to meet in person, both users visit a centralized registration and authentication website and register with the underlying system by submitting a mobile phone number through the website. The system generates and sends a unique code via a text messaging means to the user's mobile phone. The user returns to the registration website and enters the unique code, and the system prompts the user to submit further identifying information. If the user's further identifying information can be verified, the user is recorded as fully authenticated in the system's database. The system generates an identification code specific to each user that is linked to that user for a predetermined period of time. The system then sends a notice of full authentication to interested parties. After both the buyer and seller are fully authenticated, the system sends both parties a single confirmation code as well as the other party's photograph. When the buyer and seller meet, both parties may bring the others photo to the meeting in order to establish identity before reaching a potentially vulnerable proximity. Both parties may also bring the confirmation code as a last measure of establishing identity verification.

### ADVANTAGES

A method and system as described herein has the advantages of (1) allowing casual buyers and sellers and sales professionals an opportunity to verify a strangers identity before meeting in a potentially dangerous situation, (2) gathering buyers'/sellers' contact information in a centralized database which can be used for other purposes such as marketing, and (3) providing a convenient way to alert interested parties of a buyer's/seller's “safe” status. This method and system also provides a means for tracking potential buyer visits, ensuring that causal buyers/sellers and sales professionals have the correct contact information, and ensuring that a buyer's/seller's driver's license or other identifying document has already been recorded in the event of a dangerous or negative occurrence, such as theft, assault, or homicide.

### BRIEF DESCRIPTION OF THE DRAWINGS

Various embodiments of the present invention are described herein by way of example in connection with the following figures, wherein:

FIG. 1 is a schematic view of a system is accordance with the present invention;

FIG. 2 is a logical flow diagram showing the overall operation of the present invention; and

FIG. 3 is a logical flow diagram depicting in greater detail the means to indicate mutual interest step 140 of FIG. 2.

### DETAILED DESCRIPTION

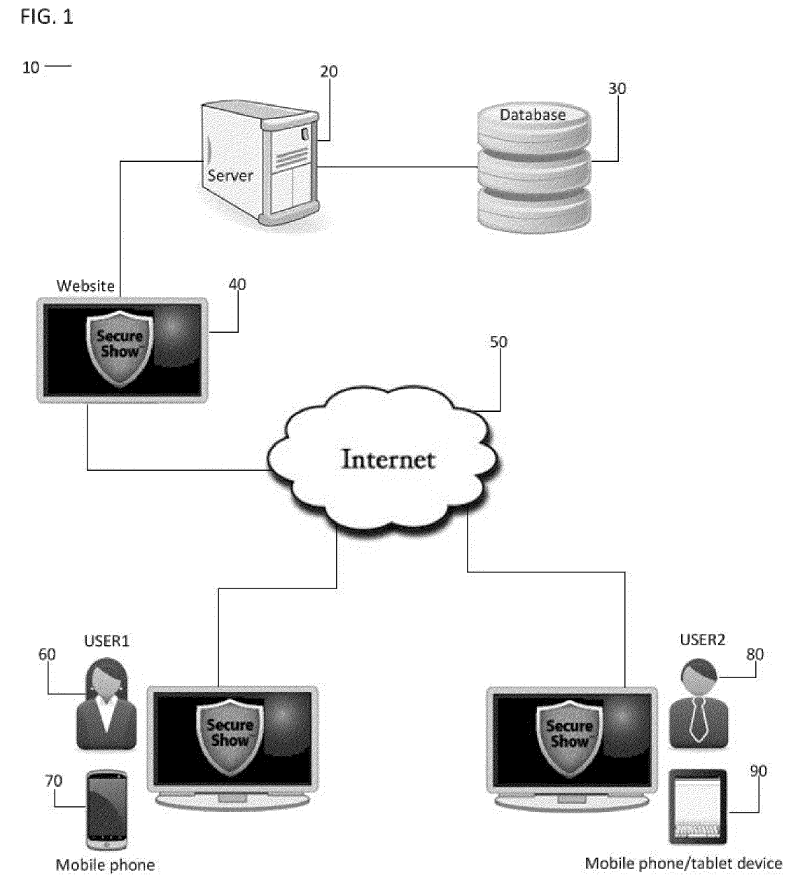

FIG. 1 shows the system architecture of the present invention. An authentication system 10 consists of a database 30 connected to a computer server 20 which is connected to the internet 50 and hosts a website 40 which provides the means for users 60, 70 to register a username, verify their mobile phone 70 numbers and identity, indicate interest or disinterest in another user, and receive some of another user's authenticated information before meeting in person.

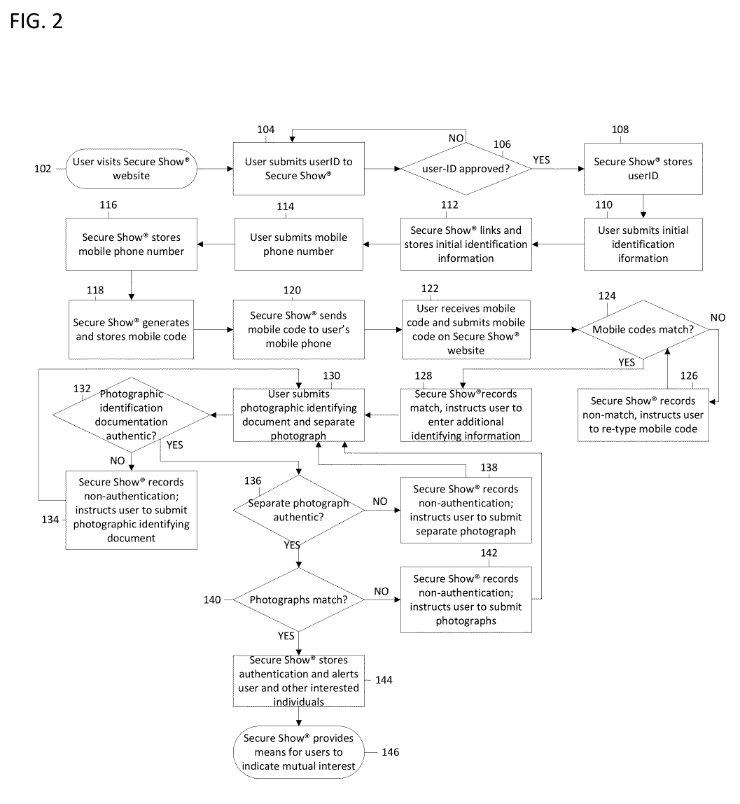

FIG. 2 shows, in its broadest sense, operation of the system 10.

102—First, a user visits a registration and authentication system 10 website 40. In this embodiment, the website 40 and its system 10 are named Secure Show®. This applicant has acquired federal trademark protection for the Secure Show® mark for identification verification services. Other entities may license the Secure Show® authentication system 10 for embedded use in their own website, and other websites may employ a redirect method so that an interface directs users to a Secure Show® website 40.

104—Upon system 10 registration, a potential user submits a user identity (“userID”) and password to the Secure Show® website 40

106—The Secure Show® system 10 approves or rejects the userID and password, based on standard predetermined userID and password data validation such as length, special characters, security, and propriety. If the user's selected userID and/or password is not approved, the Secure Show® system 10 directs the user to enter an alternate userID and/or password until both userID and password are accepted. In other embodiments, the Secure Show® system 10 selects the user-ID.

108—The Secure Show® system 10 stores the userID and password in the system 10 database 30.

110—The user submits initial identifying information to the Secure Show® system 10 via the website 40. In this embodiment, this information includes at least the user's email address, which is subject to standard email address data validation. In other embodiments, users submit these and additional identifying data.

112—When the user's email address is validated, the Secure Show® system 10 stores the initial identifying information and links it to the userID.

114—The user submits their mobile phone 70 number to the Secure Show® website 40. In this embodiment, the mobile phone 70 number is associated with a mobile smart phone 70 with text messaging capabilities, but in other embodiments, the mobile number may be associated with a tablet or other mobile device 90 that uses a telephone number to affect text messaging capabilities.

116—The Secure Show® system 10 stores the mobile phone 70 number, links it to the userID, and increments/stores a mobile phone 70 number submission count, inhere are more than a predetermined number of attempts at entering a mobile number for a particular userID, an error is generated, and the user and a Secure Show® system 10 administrator are alerted.

118—The Secure Show® system 18 generates a mobile code specific to the users mobile number, links this mobile code to the user-ID, and stores the mobile code for a predetermined length of time for later comparison.

120—The Secure Show® system 10 sends the mobile code to the user's mobile phone 70 and increments/stores a mobile code send count. If there are more than a predetermined number of attempts at sending a mobile code for a particular mobile phone 70 number, an error is generated, and the user and a Secure Show® system 10 administrator are alerted.

122—The user receives the mobile code and logs in to the Secure Show® website 40 to type the code in for verification. In other embodiments, there is a predetermined length of time within which the user must return to the website 40 and accurately enter the code. If the predetermined length of time expires, the user will be instructed to resubmit information which causes the Secure Show® system 10 to return to step 118 to generate, store, and send a new mobile code to the user's mobile phone 70.

124—The Secure Show® system 10 compares its copy of the verification code with the user-returned verification code.

126—If the user submits an inaccurate mobile code, the Secure Show® system 10 records the non-match and increments/stores a non-match count. The user has a predetermined number of attempts to submit the mobile code accurately before art error is generated and the user will be instructed to resubmit information which causes the Secure Show® system 10 to return to step 118 to generate, store, and send a new mobile code to the user's mobile phone 70.

128—If the mobile codes do match, the Secure Show® system 10 records the match and instructs the user to submit an electronic copy of a photographic identification document (such as a drivers license, state identification card, passport, or other government-issued photo identification) as well as a separate photograph to the Secure Show® system 10. The separate photograph must be different than the photograph on the identification document, and it must meet predetermined Secure Show® standards that relate to document validation.

130—The user submits an electronic copy of his/her photographic identification document to the Secure Show® system 10. The user also submits an electronic copy of his/her separate photograph to the Secure Show® system 10. The Secure Show® system 10 increments/stores a document submission count every time the user submits materials, and if the user attempts to submit more than a predetermined number of documents, an error is generated, and the user and a Secure Show® system 10 administrator are alerted.

132—A Secure Show administrator will determine whether the photographic identification document meets predetermined authenticity standards. In this embodiment, this and other comparisons are performed by a human Secure Show® administrator. In another embodiment, a third-party comparison system may be used for this and other comparisons, using automated technology such as photographic matching software and/or facial recognition means. In other embodiments, a combination of human-administered and automated comparison means may be used.

134—If the Secure Show® administrator does not determine that the photographic identification document meets predetermined authenticity standards, the Secure Show® system 10 records non-authentication of this document and instructs the user to submit a more legible copy of the document or a different photographic identification document.

135—If the Secure Show® administrator determines that the photographic identification document does meet predetermined authenticity standards, it will determine whether the separate photograph also meets predetermined authenticity standards.

138—If the Secure Show® administrator does not determine that the separate photograph meets predetermined authenticity standards, the Secure Show® system 10 records non-authentication of this document and instructs the user to submit a clearer copy of the document or a different separate photograph.

140—if the Secure Show® administrator determines that the separate photograph does meet predetermined authenticity standards, it will determine whether the photographic identification document and the separate photograph match one another.

142—If the Secure Show® administrator is not able to verify that the photographic identification document and the separate photograph match, the Secure Show® system 10 records non-authentication based on discrepant photographs and instructs the user to re-submit a photographic identification document and/or a separate photograph.

144—If the Secure Show® administrator determines that the photographic identification document and the separate photograph match, the Secure Show® system 10 records the user as authenticated. The Secure Show® system 10 sends a message to the user, welcoming them and letting them know they have been authenticated. All qualified, interested parties will be alerted tea user's authenticated status. Contemplated means of alerting interested parties include email, mobile phone messaging, voicemail, and posting notice of authentication on a Secure Show® website 40.

146—The Secure Show® website 40 provides a means for users to indicate mutual interest in one other as parties to a potential transaction.

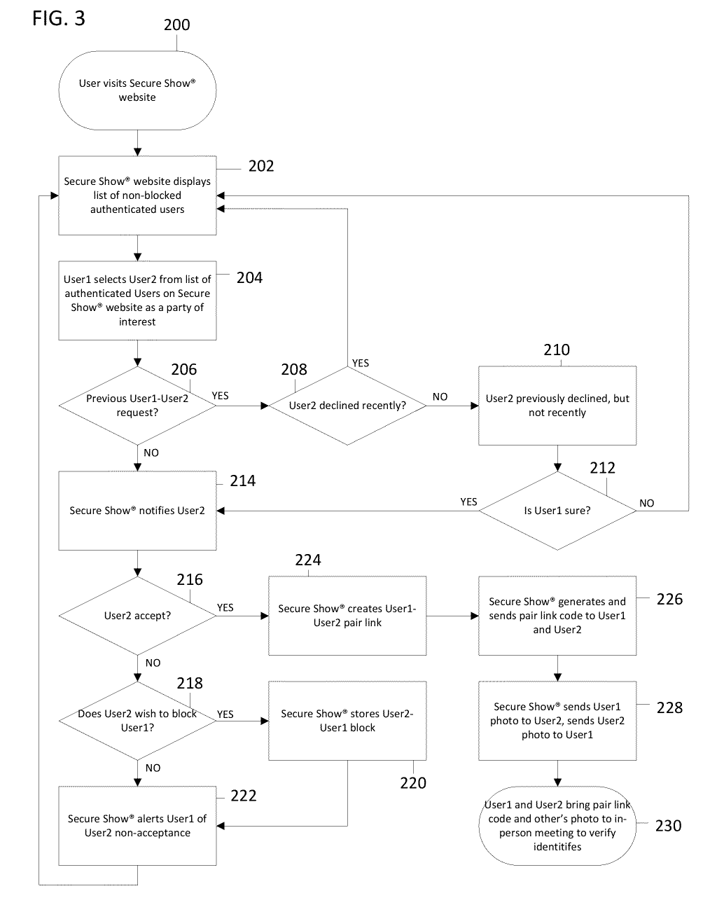

Referring to FIG. 3, the Secure Show® system 10 provides a means by which authenticated users 60, 70 may indicate mutual interest in one another.

200—User1 60, an authenticated user, log in to the Secure Show® website 40.

202—The Secure Show® website 40 displays a list of non-blocked, authenticated users.

204—User1 60 selects User2 80 from list of authenticated users on the Secure Show® website 40 as a party of interest.

206—The Secure Show® system 10 checks the interest between User1 60 and 80.

208—If User2 80 has already declined User1's 60 interest in a predetermined recent period, the Secure Show® system 10 will alert User1 60 of such non-interest and return to step 202 to display a list of authenticated, non-blocked users.

210—If User2 80 has already declined User1's 60 interest in a predetermined non-recent period, the Secure Show® system 10 will alert User1 66 of such non-interest and ask User1 to confirm their interest in User2 80 in step 212. If User1 does not confirm, the Secure Show® system 10 will return to step 202 to display a list of authenticated, non-blocked users.

214—If User1 60 does con firm their interest in User2 80, the Secure Show® system 10 notifies User2 80.

216—User 2 80 is asked to accept User1 60 as a mutually interested party.

218—If User2 80 declines, the Secure Show® system 10 increments/stores a User1-User2 decline count and the timestamp of decline, and the Secure Show® system 10 communicates User2's 80 decline to User1 60.

220—The Secure Show® system 10 asks User2 80 if they wish to block User1 60. The Secure Show® system 10 records the block record with User2's 80 userID.

222—The Secure Show® system 10 alerts User1 60 of User2's 80 non-acceptance and returns to step 202 to display a list of authenticated, non-blocked users.

224—If User2 80 accepts User1's 60 interest, the Secure Show® system 10 communicates User2's 80 acceptance to User1 60 and creates and stores a User1-User2 pair link and timestamp of acceptance.

226—The Secure Show® system 10 generates, stores, and sends a single pair link code to User1 60 and User2 80. Contemplated means of transmitting the code to the users include email, mobile phone messaging, and posting to a restricted-access web page. In other embodiments, this pair link code is only valid for a predetermined length of time, after which it must be regenerated by a user's attempt to indicate interest.

228—The Secure Show® system 10 sends User1's 80 photo User2 80, and User2's 80 photo to User1 80. Contemplated means of transmitting the photograph to the users include email, mobile phone messaging, and posting to a restricted-access web page.

230—User1 60 and User2 80 bring pair link code and the other's photo to their in-person meeting. The users may bring the photograph to an in-person meeting to confirm the other users identity before coming within a potentially vulnerable personal range. The users may also use the code to confirm the others authenticated status upon meeting in person.

What is claimed is:

1. A computer-based method for users to register a username, verify their mobile phone number and identity, indicate interest or disinterest in another user, and receive some of another user's authenticated information before meeting in person, comprising:
providing a website which enables said user to enter identifying information, said identifying information including at least a user-ID, email address, mobile phone number, an electronic copy of a photographic identification document, and a separate photograph;
validating and storing said identifying information in a database;
generating a mobile phone code that is sent to said user's said mobile phone number and stored in said database with said user-ID;
verifying that said user has returned to said website and entered said mobile phone code correctly;
verifying that the information contained in said user's said photographic identification document meets predetermined authenticity standards;
verifying that said separate photograph meets predetermined authenticity standards;
verifying that the photograph in said photographic identification document matches said separate photograph;
recording said user as authenticated in said database;
alerting interested parties of said user's authentication status;
providing a means by which mutually interested authenticated users can indicate interest as a user-pair;
generating and storing a user-pair code for said mutually interested authenticated users and sending said user-pair code to both said mutually interested authenticated users; and
sending each member of said user-pair the opposite user's said separate photograph.

2. A computer-based authentication system for users to register a user name, verify their mobile phone number and identity, indicate interest or disinterest in another user, and receive some of another user's authenticated information before meeting in person, comprising:
an internet-based module providing a website which enables said user to enter identifying information, said identifying information including at least a user-ID, password, email address, mobile phone number, an electronic copy of a photographic identification document, and a separate photograph;
a storage module for storing said identifying information in a database;
a code-generation module for generating a mobile phone code that is sent to said user's said mobile phone number and to said database;
a verification module for verifying that said user has returned to said website and entered said mobile phone code correctly;
a verification module for verifying that information contained in said user's said electronic image matches said user's said identifying information;
a storage module for recording said user as authenticated in said database; and
a communication module for alerting interested parties of said user's authentication status.

3. A computer-readable medium including instructions for performing a method for users to register a username, verify their mobile phone number and identity, indicate interest or disinterest in another user, and receive some of another user's authenticated information before meeting in person, comprising:
instructions for providing a website which enables said user to enter identifying information, said identifying information including at least a mobile phone number and a electronic image of an identification document;
instructions for storing said identifying information in a database;
instructions for generating a code that is sent to said user's said mobile phone number and to said database;
instructions for verifying that said user has returned to said website and entered said code correctly;
instructions for verifying that information contained in said user's said electronic image matches said user's said identifying information;
instructions for recording said user as authenticated in said database; and
instructions for alerting interested parties of said user's authentication status.
